(19) United States
(12) Patent Application Publication
(10) Pub. No.: US 2013/0274155 A1
(43) Pub. Date: Oct. 17, 2013

(54) PROCESS TO CONTROL IRON IN OIL AND GAS APPLICATIONS USING A CHELATING AGENT

(71) Applicants: Hisham Nasr-El-Din, College Station, TX (US); James N. Lepage, Chicago, IL (US); Cornelia Adriana De Wolf, Eerbeek (NL); Mohamed Ahmed Nasr-El-Din Mahmoud, Dhahran (SA); Ahmed Issam Elsayed Salama Assem, College Station, TX (US)

(72) Inventors: Hisham Nasr-El-Din, College Station, TX (US); James N. Lepage, Chicago, IL (US); Cornelia Adriana De Wolf, Eerbeek (NL); Mohamed Ahmed Nasr-El-Din Mahmoud, Dhahran (SA); Ahmed Issam Elsayed Salama Assem, College Station, TX (US)

(73) Assignee: AKZO NOBEL CHEMICALS INTERNATIONAL B.V., Amersfoort (NL)

(21) Appl. No.: 13/993,489

(22) PCT Filed: Dec. 14, 2011
(86) PCT No.: PCT/EP2011/072695

§ 371 Date: Jun. 12, 2013

Related U.S. Application Data
(60) Provisional application No. 61/424,346, filed on Dec. 17, 2010.

(30) Foreign Application Priority Data
Jan. 21, 2011 (EP) 11151726.4

(51) Int. Cl. C09K 8/528

(52) U.S. Cl. CPC C09K 8/528
USPC 507/241

(57) ABSTRACT

The present invention relates to a process to control iron in a subterranean formation wherein a fluid containing glutamic acid N,N-diacetic acid or a salt thereof (GLDA) and/or methylglycine N,N-diacetic acid or a salt thereof (MGDA) is introduced into the formation at a temperature between 77 and 400° F. (about 2 and 204° C.). The invention also covers a process of treating a subterranean formation wherein simultaneously iron control takes place.

The present invention relates to a process to control iron in oil and gas applications using a fluid containing glutamic acid N,N-diacetic acid or a salt thereof (GLDA) and/or methylglycine N,N-diacetic acid or a salt thereof (MGDA).

Subterranean formations from which oil and/or gas can be recovered can contain several solid materials contained in porous or fractured rock formations. The naturally occurring hydrocarbons, such as oil and/or gas, are trapped by the overlying rock formations with lower permeability. The reservoirs are found using hydrocarbon exploration methods and often one of the purposes of withdrawing the oil and/or gas therefrom is to improve the permeability of the formations. The rock formations can be distinguished by their major components, and one category is formed by the so-called sandstone formations, which contain siliceous materials as the major constituent, and another category is formed by the so-called carbonate formations, which contain carbonates as the major constituent.

One process to make formations more permeable is a matrix acidizing process, wherein an acidic fluid is introduced into the formations trapping the oil and/or gas. In a process of matrix acidizing, frequently iron contaminations cause problems in that dissolved iron salts precipitate or form gels with organic or inorganic components present or introduced into the reservoir, thereby leading to the flow of liquids through the formation being hindered.

Dissolved iron can originate from contaminated acid, dissolution of rust in the coiled tubing or well casing or tubular, acid corrosion of steel, dissolution of iron-containing minerals in the formation (e.g. chlorite, hematite, and ankerite), corrosion products present in the wellbore, or corroded surface equipment used during an acid treatment.

From previous studies of iron contamination during acidizing, it was found that the largest source of dissolved iron comes from the reaction of the acid with corrosion products present on the equipment. This is the most significant route, because the surface area of the equipment is very large in comparison with the acid volume.

Taylor, K. C, Nasr-el-din, H. A., Al-Alawi, M. J. in “A Systematic Study of Iron Control Chemicals Used During Well Stimulation,” presented at the 1998 SPE International Symposium on Formation Damage Control, Lafayette, Louisiana, 18-19 Feb. 1998, published as SPE 39419 and Taylor, K. C, Nasr-el-din, H. A. in “A Systematic Study of Iron Control Chemicals—Part 2,” presented at the 1999 SPE International Symposium on Oilfield Chemistry, Houston, Tex., 16-19 Feb. 1999, published as SPE 50772, disclose several iron control chemicals used during well stimulation. The chemicals investigated are organic acids and a few of them are also considered to be chelating agents. It was established that EDTA is not a good iron control chemical as it has low acid solubility and low iron complexing capacity under acidizing conditions, and that when using NTA, there is a risk of Fe/Ca/NTA precipitation.

Frenier, W. W., Wilson, D., Crump, D., and Jones, L. in “Use of Highly Acid-Soluble Chelating Agents in Well Stimulation Services,” Paper SPE 63242 presented at the SPE Annual Technical Conference and Exhibition held in Dallas, Tex., 1-4 Oct. 2000, DOI: 10.2118/63242-MS, show that HEDTA and HEIDA are capable of recovering iron in 15% HCl fluids at 190° F. and that NTA is less temperature stable.

LePage, J. N., De Wolf, C. A., Bemelaar, J. H., Nasr-el-Din, H. A. in “An Environmentally Friendly Stimulation Fluid for High-Temperature Applications,” presented at the SPE International Symposium on Oilfield Chemistry, The Woodlands, Tex., 20-22 Apr. 2009, published as SPE 121709, disclose that GLDA is suitable to chelate iron at room temperature. However, in this document no core flooding experiments were performed, so the performance of GLDA in cores was not really demonstrated. Also, no experiments were performed at elevated temperatures.

The present invention aims to provide a process and a fluid to control iron in subterranean formations to a far greater extent, which process and fluid give improved functionality over the broad temperature range that can be found in formations and a combined stimulation and iron control even after the acidizing chemicals in the fluid are spent.

Accordingly, the present invention involves a process to control iron wherein a fluid containing glutamic acid N,N-diacetic acid or a salt thereof (GLDA) and/or methylglycine N,N-diacetic acid or a salt thereof (MGDA) is introduced into a subterranean formation at a temperature between 77 and 400° F. (about 25 and 204° C.).

The term “iron control” for the purpose of this application means the prevention or at least reduction of Fe(III)OH₃ precipitation. Fe(III)OH₃ precipitates are formed in a formation during treatment thereof (treatment as defined below) as a consequence of iron cations that are naturally present in the formation or iron cations that originate from the dissolution of iron from the equipment used and the slow increase of the pH during treatment because acid is spent. While the presence of iron cations may have other disadvantages when treating subterranean formations, the formation of ferric hydroxide solids is a substantial problem in formation treatments, because in many cases it leads to formation damage. In some embodiments iron control also means the prevention of asphaltic sludge, by preventing the polar groups in asphaltenes from reacting with the ferric iron. Iron control in some embodiments also means prevention or at least reduction of the precipitation of any other type of insoluble iron salt, especially iron sulfides. Iron sulfides are formed in the well and near-wellbore area especially in sour wells, i.e. wells containing H₂S.

It should be noted that WO 2009/086954 discloses that an acidic solution containing GLDA is capable of preventing iron precipitates but nowhere in this document is it disclosed or suggested that a fluid containing GLDA is capable of controlling iron, i.e. reducing ferric hydroxide precipitation, in subterranean formations. WO 2009/086954 is also silent on the fact that reducing ferric hydroxide precipitation in subterranean formations may improve or at least preserve the permeability of the formation and reduce undesired formation damage to a great extent, and that such fluid gives improved functionality over the broad temperature range applied during the process of the invention in the formations and a combined stimulation and iron control even after the acidizing chemicals in the fluid are spent.

The process of the invention is advantageous as it provides a combination of iron control and an excellent acidity, which leads to improved permeability of the formation and increased removal of undesired inorganics, both deeper in the formation and for a prolonged time. As GLDA and MGDA are highly soluble at acidic pHs, the fluids of the present invention provide an increased iron binding capacity in a treatment fluid. This is especially important when an acidizing treatment is performed under optimal conditions for any particular well. Under optimal conditions in terms of injection rate and treatment volume the treatment fluids propagate far into the formation and iron should be controlled for an increased period of time in an optimized amount of fluid (i.e. a minimal amount of fluid leading to high iron concentrations and high risk of iron precipitation), which in core flooding studies is simulated by measuring the iron recovery, i.e. the percentage of iron controlled by the chelating agent under breakthrough conditions, all of which represents the optimal conditions to create a wormhole through the entire length of the core with the optimized, i.e. minimal, amount of liquid leading to high iron concentrations and a high risk of iron precipitation. The process of the invention was found to give an improvement in iron control also for such acidizing treatments during which controlling iron is a challenge. The process of the present invention is also advantageous in that it does not require the use of any toxic or carcinogenic chemicals, as NTA is registered as a suspected carcinogen for humans. The process of the invention can not only be performed over a broad temperature range, it can also be performed over a broad pH range.

In accordance with the present invention a process is provided to control iron in any subterranean formation in which (contaminating amounts of) iron may cause a problem. The present invention thus also provides an improved and prolonged process of treating such a formation with a fluid that contains MGDA and/or GLDA and controlling iron at the same time.

At the same time, it was found that in the process of the invention the presence of GLDA and/or MGDA ensures that smaller amounts of some usual additives such as corrosion inhibitors, corrosion inhibitor intensifiers, anti-sludge agents, iron control agents, scale inhibitors are needed to still achieve a similar effect to that of state of the art stimulation fluids, reducing the chemicals burden of the process and creating a more sustainable way to produce oil and/or gas. Under some conditions these additives are even completely redundant.

In addition, in combination with a biocide or bactericide the GLDA and/or MGDA reduces the number of and sometimes even fully removes the bacteria that are responsible for the formation of sulfides from sulfate. As iron forms a precipitate with sulfide, also in this way iron control takes place. It has even been found that the combination of GLDA and/or MGDA with a biocide or bactericide is synergistic, i.e. less biocide or bactericide is required to control the growth of microorganisms in the presence of GLDA and/or MGDA, reducing the negative environmental effect of using large quantities of biocides or bactericides with their inherent negative eco-tox profile.

The term treating in this application means to cover any treatment of the formation with the fluid. It specifically covers treating the formation with the fluid to achieve at least one of (i) an increased permeability, (ii) the removal of small particles, and (iii) the removal of inorganic scale, and so enhance the well performance and enable an increased recovery/production of oil and/or gas from the formation. At the same time it may cover cleaning of the wellbore and descaling of the oil/gas production well and production equipment.

The subterranean formation can be of any nature and in one embodiment is a sandstone or a carbonate formation. Sandstone formations contain siliceous materials, like quartz, as the major constituent and may contain various amounts of clays (aluminosilicates such as kaolinite or illite) or alkaline aluminosilicates such as feldspars, and zeolites, as well as carbonates (calcite, dolomite, ankerite) and iron based minerals (hematite and pyrite). Carbonate formations contain calcium carbonates (dolomite and calcite) as the major constituent.

Unlike other chelating agents, GLDA is soluble in many acids in basically every concentration, as can be found in WO 2009/086 954; this is an additional advantage in the process of the present invention. In addition, also relatively concentrated solutions (more than 20 wt %) can be made of both MGDA and GLDA which have an acidic pH (of around 3 for MGDA and even below pH of 3 for GLDA).

Preferably, the fluid in addition contains an acid, preferably an inorganic acid, to assist in treating the formation, such as HCl or HF. This (inorganic) acid suitably is used in an amount of between 3 and 28 wt % on the basis of the total weight of the fluid and especially in the embodiments wherein GLDA is used, there is a lot of freedom to choose from acids and concentrations.

In another preferred embodiment, the fluid contains a corrosion inhibitor. This corrosion inhibitor is suitably used in an amount of between 0.1 and 2 volume % on the basis of the total volume of the fluid.

The amount of GLDA and/or MGDA in the fluid is preferably between 0.1 and 30 wt %, more preferably between 5 and 30 wt %, even more preferably between 10 and 20 wt % on the basis of the total weight of the fluid. It is to be understood that the amount of chelating agent can be lower when another acid is present in the fluid and the chelating agent in such embodiment is primarily added as an iron control agent and less to function as an acid in treating the formation.

Salts of GLDA and/or MGDA that can be used are their alkaline metal, alkaline earth metal, or ammonium full and partial salts. Also mixed salts can be used containing different cations. Preferably, the sodium, potassium, and ammonium full or partial salts of GLDA and/or MGDA are used.

In a preferred embodiment GLDA is used in the process of the invention.

The fluids of the invention are preferably aqueous fluids, i.e. they preferably contain water as a solvent for the other ingredients, wherein water can be e.g. fresh water, produced water or seawater, though other solvents may be added as well, as further explained below.

In one embodiment, the pH of the fluids of the invention can be up to 8, preferably ranging from 1 to 8. More preferably, however, it is between 3.5 and 8, as in the very acidic ranges of 1 to 3.5 some undesired side effects may be caused by the fluids in the formation, such as too fast dissolution of carbonate giving excessive CO₂ formation or an increased risk of reprecipitation. For a better carbonate dissolving and iron control capacity it is preferably acidic. On the other hand, it must be realized that highly acidic solutions are more expensive to prepare. Consequently, the solution even more preferably has a pH of 4 to 7.

According to the invention, the fluids are used at a temperature of between 77 and 400° F. (about 25 and 204° C.). Preferably, the fluids are used at a temperature where they best achieve the desired effects, which means a temperature of between 77 and 300° F. (about 25 and 149° C.).

The use of the fluids is preferably at a pressure between atmospheric pressure and fracture pressure, wherein fracture pressure is defined as the pressure above which injection of fluids will cause the formation to fracture hydraulically.

High temperature applications may benefit from the presence of an oxygen scavenger in an amount of less than about 2 volume percent of the solution.

The fluid of the invention may contain one or more of the group of mutual solvents, anti-sludge agents, (water-wetting or emulsifying) surfactants, corrosion inhibitor intensifiers, foaming agents, viscosifiers, wetting agents, diverting agents, oxygen scavengers, carrier fluids, fluid loss additives, friction reducers, stabilizers, rheology modifiers, gelling agents, scale inhibitors, breakers, salts, brines, pH control additives such as further acids and/or bases, bactericides/biocides, particulates, crosslinkers, salt substitutes (such as tetramethyl ammonium chloride), relative permeability modifiers, sulfide scavengers, fibres, nanoparticles, and, in sandstone formations, consolidating agents (such as resins and/or tackifiers), combinations thereof, or the like.

As indicated above, the subterranean formation can be of any nature and in some embodiments is a sandstone or a carbonate formation. It is to be understood that different formations sometimes make different additives desirable.

The mutual solvent is a chemical additive that is soluble in oil, water, acids (often HCl based), and other well treatment fluids. Mutual solvents are routinely used in a range of applications, controlling the wettability of contact surfaces before, during and/or after a treatment, and preventing or breaking emulsions. Mutual solvents are used, as insoluble formation fines pick up organic film from crude oil. These particles are partially oil-wet and partially water-wet. This causes them to collect material at any oil-water interface, which can stabilize various oil-water emulsions. Mutual solvents remove organic films leaving them water-wet, thus emulsions and particle plugging are eliminated. If a mutual solvent is employed, it is preferably selected from the group which includes, but is not limited to, lower alcohols such as methanol, ethanol, 1-propanol, 2-propanol, and the like, glycols such as ethylene glycol, propylene glycol, diethylene glycol, dipropylene glycol, polyethylene glycol, polypropylene glycol, polyethylene glycol-polyethylene glycol block copolymers, and the like, and glycol ethers such as 2-methoxyethanol, diethylene glycol monomethyl ether, and the like, substantially water/oil-soluble esters, such as one or more C2-esters through C10-esters, and substantially water/oil-soluble ketones, such as one or more C2-C10 ketones, wherein substantially soluble means soluble in more than 1 gram per liter, preferably more than 10 grams per liter, even more preferably more than 100 grams per liter, most preferably more than 200 grams per liter. The mutual solvent is preferably present in an amount of 1 to 50 wt % on total fluid.

A preferred water/oil-soluble ketone is methyl ethyl ketone.

A preferred substantially water/oil-soluble alcohol is methanol.

A preferred substantially water/oil-soluble ester is methyl acetate.

A more preferred mutual solvent is ethylene glycol monobutyl ether, generally known as EGMBE.

The amount of glycol solvent in the solution is preferably about 1 wt % to about 10 Wt %, more preferably between 3 and 5 wt %. More preferably, the ketone solvent may be present in an amount from 40 wt % to about 50 wt %; the substantially water-soluble alcohol may be present in an amount within the range of about 20 wt % to about 30 wt %; and the substantially water/oil-soluble ester may be present in an amount within the range of about 20 wt % to about 30 wt %, each amount being based upon the total weight of the solvent in the fluid.

The surfactant can be any surfactant known in the art and can be nonionic, cationic, anionic, zwitterionic. When the formation is a carbonate formation, preferably, the surfactant is nonionic or cationic and even more preferably, the surfactant is cationic. When the formation is a sandstone formation, preferably, the surfactant is nonionic or anionic, and even more preferably the surfactant is anionic.

The nonionic surfactant of the present composition is preferably selected from the group consisting of alkanolamides, alkoxylated alcohols, alkoxylated amines, amine oxides, alkoxylated amides, alkoxylated fatty acids, alkoxylated fatty amines, alkoxylated alkyl amines (e.g., cocoalkyl amine ethoxylate), alkyl phenyl polyethoxylates, lecithin, hydroxylated lecithin, fatty acid esters, glycerol esters and their ethoxylates, glycol esters and their ethoxylates, esters of propylene glycol, sorbitan, ethoxylated sorbitan, polyglycosides and the like, and mixtures thereof. Alkoxylated alcohols, preferably ethoxylated alcohols, optionally in combination with (alkyl) polyglycosides, are the most preferred nonionic surfactants.

The anionic (sometimes zwitterionic, as two charges are combined into one compound) surfactants may comprise any number of different compounds, including sulfonates, hydrolyzed keratin, sulfosuccinates, taurates, betaines, modified betaines, alkylamidobetaines (e.g., cocoamidopropyl betaine).

The cationic surfactants may comprise quaternary ammonium compounds (e.g., trimethyl tallow ammonium chloride, trimethyl cocoammonium chloride), derivatives thereof, and combinations thereof.

Examples of surfactants that are also foaming agents that may be utilized to foam and stabilize the treatment fluids of this invention include, but are not limited to, betaines, amine oxides, methyl ester sulfonates, alkylamidobetaines such as cocoamidopropyl betaine, alpha-olefin sulfonate, trimethyl tallow ammonium chloride, C8 to C22 alkyl ethoxylate sulfate, and trimethyl coco ammonium chloride.

Suitable surfactants may be used in a liquid or powder form.

Where used, the surfactants may be present in the fluid in an amount sufficient to prevent incompatibility with formation fluids, other treatment fluids, or wellbore fluids at reservoir temperature.

In an embodiment where liquid surfactants are used, the surfactants are generally present in an amount in the range of from about 0.01% to about 5.0% by volume of the fluid.

In one embodiment, the liquid surfactants are present in an amount in the range of from about 0.1% to about 2.0% by volume of the fluid, preferably from 0.1 to 1.0 volume %.

In embodiments where powdered surfactants are used, the surfactants may be present in an amount in the range of from about 0.001% to about 0.5% by weight of the fluid.

The anti-sludge agent can be chosen from the group of mineral and/or organic acids used to stimulate the formation when it is a carbonate, limestone, dolomite, and sandstone hydrocarbon-bearing formation. The function of the acid is to dissolve acid-soluble materials so as to clean or enlarge the flow channels of the formation leading to the wellbore, allowing more oil and/or gas to flow to the wellbore.

Problems are caused by the interaction of the (usually concentrated, 20-28%) stimulation acid and certain crude oils (e.g. aphaltic oils) in the formation to form sludge. Interaction studies between sludging crude oils and the introduced acid show that permanent rigid solids are formed at the acid-oil interface when the aqueous phase is below a pH of about 4. No films are observed for non-sludging crudes with acid.

These sludges are usually reaction products formed between the acid and the high molecular weight hydrocarbons such as asphaltenes, resins, etc.

Methods for preventing or controlling sludge formation with its attendant flow problems during the acidization of crude-containing formations include adding “anti-sludge” agents to prevent or reduce the rate of formation of crude oil sludge, which anti-sludge agents stabilize the acid-oil emulsion and include alkyl phenols, fatty acids, and anionic surfactants. Frequently used as the surfactant is a blend of a sulfonic acid derivative and a dispersing surfactant in a solvent. Such a blend generally has dodecyl benzene sulfonic acid (DDBSA) or a salt thereof as the major dispersant, i.e. anti-sludge, component.

The carrier fluids are aqueous solutions which in certain embodiments contain a Bronsted acid to keep the pH in the desired range and/or contain an inorganic salt, preferably NaCl or KCl.

Corrosion inhibitors may be selected from the group of amine and quaternary ammonium compounds and sulfur compounds. Examples are diethyl thiourea (DETU), which is suitable up to 185° F. (about 85° C.), alkyl pyridinium or quinolinium salt, such as dodecyl pyridinium bromide (DDPB), and sulfur compounds, such as thiourea or ammonium thiocyanate, which are suitable for the range 203-302° F. (about 95-150° C.), benzotriazole (BZT), benzimidazole (BZI), dibutyl thiourea, a proprietary inhibitor called TIA, and alkyl pyridines.

In general, the most successful inhibitor formulations for organic acids and chelating agents contain amines, reduced sulfur compounds or combinations of a nitrogen compound (amines, quats or polyfunctional compounds) and a sulfur compound. The amount of corrosion inhibitor is preferably between 0.1 and 2.0 volume %, more preferably between 0.1 and 1.0 volume % on total fluid.

One or more corrosion inhibitor intensifiers may be added, such as for example formic acid, potassium iodide, antimony chloride, or copper iodide.

One or more salts may be used as rheology modifiers to modify the rheological properties (e.g., viscosity and elastic properties) of the treatment fluids. These salts may be organic or inorganic.

Examples of suitable organic salts include, but are not limited to, aromatic sulfonates and carboxylates (such as p-toluene sulfonate and naphthalene sulfonate), hydroxynaphthalene carboxylates, salicylate, phthalate, chlorobenzoic acid, phthalic acid, 5-hydroxy-1-naphthoic acid, 6-hydroxy-1-naphthoic acid, 7-hydroxy-1-naphthoic acid, 1-hydroxy-2-naphthoic acid, 3-hydroxy-2-naphthoic acid, 5-hydroxy-2-naphthoic acid, 7-hydroxy-2-naphthoic acid, 1,3-dihydroxy-2-naphthoic acid, 3,4-dichlorobenzoate, trimethyl ammonium hydrochloride, and tetramethyl ammonium chloride.

Examples of suitable inorganic salts include water-soluble potassium, sodium, and ammonium halide salts (such as potassium chloride and ammonium chloride), calcium chloride, calcium bromide, magnesium chloride, sodium formate, potassium formate, cesium formate, and zinc halide salts. A mixture of salts may also be used, but it should be noted that preferably chloride salts are mixed with chloride salts, bromide salts with bromide salts, and formate salts with formate salts.

Wetting agents that may be suitable for use in this invention include crude tall oil, oxidized crude tall oil, surfactants, organic phosphate esters, modified imidazolines and amidoamines, alkyl aromatic sulfates and sulfonates, and the like, and combinations or derivatives of these and similar such compounds that should be well known to one of skill in the art.

The foaming gas may be air, nitrogen or carbon dioxide. Nitrogen is preferred.

Gelling agents in a preferred embodiment are polymeric gelling agents.

Examples of commonly used polymeric gelling agents include, but are not limited to, biopolymers, polysaccharides such as guar gums and derivatives thereof, cellulose derivatives, synthetic polymers like polyacrylamides and viscoelastic surfactants, and the like. These gelling agents, when hydrated and at a sufficient concentration, are capable of forming a viscous solution.

When used to make an aqueous-based treatment fluid, a gelling agent is combined with an aqueous fluid and the soluble portions of the gelling agent are dissolved in the aqueous fluid, thereby increasing the viscosity of the fluid.

Viscosifiers may include natural polymers and derivatives such as xantham gum and hydroxyethyl cellulose (HEC) or synthetic polymers and oligomers such as poly(ethylene glycol) [PEG], poly(diallyl amine), poly(acrylamide), poly(aminomethyl propyl sulfonate) [AMPS polymer], poly(acrylonitrile), poly(vinyl acetate), poly(vinyl alcohol), poly(vinyl amine), poly(vinyl sulfonate), poly(styryl sulfonate), poly(acrylate), poly(methyl acrylate), poly(methacrylate), poly(methyl methacrylate), poly(vinyl pyrrolidone), poly(vinyl lactam) and co-, ter-, and quater-polymers of the following (co-)monomers: ethylene, butadiene, isoprene, styrene, divinyl benzene, divinyl amine, 1,4-pentadiene-3-one (divinyl ketone), 1,6-heptadiene-4-one (diallyl ketone), diallyl amine, ethylene glycol, acrylamide, AMPS, acrylonitrile, vinyl acetate, vinyl alcohol, vinyl amine, vinyl sulfonate, styryl sulfonate, acrylate, methyl acrylate, methacrylate, methyl methacrylate, vinyl pyrrolidone, and vinyl lactam. Yet other viscosifiers include clay-based viscosifiers, especially laponite and other small fibrous clays such as the polygorskites (attapulgite and sepiolite). When using polymer-containing viscosifiers, the viscosifiers may be used in an amount of up to 5% by weight of the fluid.

Examples of suitable brines include calcium bromide brines, zinc bromide brines, calcium chloride brines, sodium chloride brines, sodium bromide brines, potassium bromide brines, potassium chloride brines, sodium nitrate brines, sodium formate brines, potassium formate brines, cesium formate brines, magnesium chloride brines, sodium sulfate, potassium nitrate, and the like. A mixture of salts may also be used in the brines, but it should be noted that preferably chloride salts are mixed with chloride salts, bromide salts with bromide salts, and formate salts with formate salts.

The brine chosen should be compatible with the formation and should have a sufficient density to provide the appropriate degree of well control.

Additional salts may be added to a water source, e.g., to provide a brine, and a resulting treatment fluid, in order to have a desired density.

The amount of salt to be added should be the amount necessary for formation compatibility, such as the amount necessary for the stability of clay minerals, taking into consideration the crystallization temperature of the brine, e.g., the temperature at which the salt precipitates from the brine as the temperature drops.

Preferred suitable brines may include seawater and/or formation brines.

Salts may optionally be included in the fluids of the present invention for many purposes, including for reasons related to compatibility of the fluid with the formation and the formation fluids.

To determine whether a salt may be beneficially used for compatibility purposes, a compatibility test may be performed to identify potential compatibility problems.

From such tests, one of ordinary skill in the art will, with the benefit of this disclosure, be able to determine whether a salt should be included in a treatment fluid of the present invention.

Suitable salts include, but are not limited to, calcium chloride, sodium chloride, magnesium chloride, potassium chloride, sodium bromide, potassium bromide, ammonium chloride, sodium formate, potassium formate, cesium formate, and the like. A mixture of salts may also be used, but it should be noted that preferably chloride salts are mixed with chloride salts, bromide salts with bromide salts, and formate salts with formate salts.

The amount of salt to be added should be the amount necessary for the required density for formation compatibility, such as the amount necessary for the stability of clay minerals, taking into consideration the crystallization temperature of the brine, e.g., the temperature at which the salt precipitates from the brine as the temperature drops.

Salt may also be included to increase the viscosity of the fluid and stabilize it, particularly at temperatures above 180° F. (about 82° C.).

Examples of suitable pH control additives which may optionally be included in the treatment fluids of the present invention are acid compositions and/or bases.

A pH control additive may be necessary to maintain the pH of the treatment fluid at a desired level, e.g., to improve the effectiveness of certain breakers and to reduce corrosion on any metal present in the wellbore or formation, etc.

One of ordinary skill in the art will, with the benefit of this disclosure, be able to recognize a suitable pH for a particular application.

In one embodiment, the pH control additive may be an acid composition.

Examples of suitable acid compositions may comprise an acid, an acid-generating compound, and combinations thereof.

Any known acid may be suitable for use with the treatment fluids of the present invention.

Examples of acids that may be suitable for use in the present invention include, but are not limited to, organic acids (e.g., formic acids, acetic acids, carbonic acids, citric acids, glycolic acids, lactic acids, ethylene diamine tetraacetic acid (“EDTA”), hydroxyethyl ethylene diamine triacetic acid (“HEDTA”), and the like), inorganic acids (e.g., hydrochloric acid, and if the formation is a sandstone formation, stronger acids like hydrofluoric acid, phosphonic acid, p-toluene sulfonic acid), and combinations thereof. Preferred acids are HCl and organic acids.

Examples of acid-generating compounds that may be suitable for use in the present invention include, but are not limited to, esters, aliphatic polyesters, ortho esters, which may also be known as ortho ethers, poly(ortho esters), which may also be known as poly(ortho ethers), poly(lactides), poly(glycolides), poly(epsilon-caprolactones), poly(hydroxybutyrates), poly(anhydrides), or copolymers thereof.

Derivatives and combinations also may be suitable.

The term “copolymer” as used herein is not limited to the combination of two polymers, but includes any combination of polymers, e.g., terpolymers and the like.

Other suitable acid-generating compounds include: esters including, but not limited to, ethylene glycol monoformate, ethylene glycol diformate, diethylene glycol diformate, glyceryl monoformate, glyceryl diformate, glyceryl triformate, methylene glycol diformate, and formate esters of pentaerythritol.

The pH control additive also may comprise a base to elevate the pH of the fluid.

Generally, a base may be used to elevate the pH of the mixture to greater than or equal to about 7.

Having the pH level at or above 7 may have a positive effect on a chosen breaker being used and may also inhibit the corrosion of any metals present in the wellbore or formation, such as tubing, screens, etc.

In addition, having a pH greater than 7 may also impart greater stability to the viscosity of the treatment fluid, thereby enhancing the length of time that viscosity can be maintained.

This could be beneficial in certain uses, such as in longer-term well control and in diverting.

Any known base that is compatible with the gelling agents of the present invention can be used in the fluids of the present invention.

Examples of suitable bases include, but are not limited to, sodium hydroxide, potassium carbonate, potassium hydroxide, sodium carbonate, and sodium bicarbonate.

One of ordinary skill in the art will, with the benefit of this disclosure, recognize the suitable bases that may be used to achieve a desired pH elevation.

In some embodiments, the treatment fluid may optionally comprise a further chelating agent.

When added to the treatment fluids of the present invention, the chelating agent may chelate any dissolved iron (or other divalent or trivalent cation) that may be present in the aqueous fluid and prevent any undesired reactions being caused.

Such chelating agents may e.g. prevent such ions from crosslinking the gelling agent molecules.

Such crosslinking may be problematic because, inter alia, it may cause filtration problems, injection problems, and/or again cause permeability problems.

Any suitable chelating agent may be used with the present invention.

Examples of suitable chelating agents include, but are not limited to, citric acid, nitrilotriacetic acid (“NTA”), any form of ethylene diamine tetraacetic acid (“EDTA”), hydroxyethyl ethylene diamine triacetic acid (“HEDTA”), diethylene triamine pentaacetic acid (“DTPA”), propylene diamine tetraacetic acid (“PDTA”), ethylene diamine-N,N″-di(hydroxyphenyl acetic) acid (“EDDHA”), ethylene diamine-N,N″-di-(hydroxy-methylphenyl acetic acid (“EDDHMA”), ethanol diglycine (“EDG”), trans-1,2-cyclohexylene dinitrilotetraacetic acid (“CDTA”), glucoheptonic acid, gluconic acid, sodium citrate, phosphonic acid, salts thereof, and the like.

In some embodiments, the chelating agent may be a sodium or potassium salt.

Generally, the chelating agent may be present in an amount sufficient to prevent undesired side effects of divalent or trivalent cations that may be present, and thus also functions as a scale inhibitor.

One of ordinary skill in the art will, with the benefit of this disclosure, be able to determine the proper concentration of a chelating agent for a particular application.

In some embodiments, the fluids of the present invention may contain bactericides or biocides, inter alia, to protect the subterranean formation as well as the fluid from attack by bacteria. Such attacks can be problematic because they may lower the viscosity of the fluid, resulting in poorer performance, such as poorer sand suspension properties, for example.

Any bactericides known in the art are suitable. Biocides and bactericides that protect against bacteria that may attack GLDA or MGDA or sulfates are preferred.

An artisan of ordinary skill will, with the benefit of this disclosure, be able to identify a suitable bactericide and the proper concentration of such bactericide for a given application.

Examples of suitable bactericides and/or biocides include, but are not limited to, phenoxyethanol, ethylhexyl glycerine, benzyl alcohol, methyl chloroisothiazolinone, methyl isothiazolinone, methyl paraben, ethyl paraben, propylene glycol, bronopol, benzoic acid, imidazolinidyl urea, a 2,2-dibromo-3-nitrilopropionamide, and a 2-bromo-2-nitro-1,3-propane diol. In one embodiment, the bactericides are present in the fluid in an amount in the range of from about 0.001% to about 1.0% by weight of the fluid.

Fluids of the present invention also may comprise breakers capable of reducing the viscosity of the fluid at a desired time.

Examples of such suitable breakers for fluids of the present invention include, but are not limited to, oxidizing agents such as sodium chlorites, sodium bromate, hypochlorites, perborate, persulfates, and peroxides, including organic peroxides.

Other suitable breakers include, but are not limited to, suitable acids and peroxide breakers, triethanol amine, as well as enzymes that may be effective in breaking. The breakers can be used as is or encapsulated.

Examples of suitable acids may include, but are not limited to, hydrochloric acid, hydrofluoric acid, formic acid, acetic acid, citric acid, lactic acid, glycolic acid, etc.

A breaker may be included in a treatment fluid of the present invention in an amount and form sufficient to achieve the desired viscosity reduction at a desired time.

The breaker may be formulated to provide a delayed break, if desired.

The fluids of the present invention also may comprise suitable fluid loss additives. Such fluid loss additives may be particularly useful when a fluid of the present invention is used in a fracturing application or in a fluid used to seal a formation against invasion of fluid from the wellbore.

Any fluid loss agent that is compatible with the fluids of the present invention is suitable for use in the present invention.

Examples include, but are not limited to, starches, silica flour, gas bubbles (energized fluid or foam), benzoic acid, soaps, resin particulates, relative permeability modifiers, degradable gel particulates, diesel or other hydrocarbons dispersed in fluid, and other immiscible fluids.

Another example of a suitable fluid loss additive is one that comprises a degradable material.

Suitable examples of degradable materials include polysaccharides such as dextran or cellulose; chitins; chitosans; proteins; aliphatic polyesters; poly(lactides); poly(glycolides); poly(glycolide-co-lactides); poly(epsilon-caprolactones); poly(3-hydroxybutyrates); poly(3-hydroxybutyrate-co-hydroxyvalerates); poly(anhydrides); aliphatic poly(carbonates); poly(ortho esters); poly(amino acids); poly(ethylene oxides); poly(phosphazenes); derivatives thereof; or combinations thereof.

In some embodiments, a fluid loss additive may be included in an amount of about 5 to about 2,000 lbs/Mgal (about 600 to about 240,000 g/Mliter) of the fluid.

In some embodiments, the fluid loss additive may be included in an amount from about 10 to about 50 lbs/Mgal (about 1,200 to about 6,000 g/Mliter) of the fluid.

In certain embodiments, a stabilizer may optionally be included in the fluids of the present invention.

It may be particularly advantageous to include a stabilizer if a chosen fluid is experiencing viscosity degradation.

One example of a situation where a stabilizer might be beneficial is where the BHT (bottom hole temperature) of the wellbore is sufficient to break the fluid by itself without the use of a breaker.

Suitable stabilizers include, but are not limited to, sodium thiosulfate, methanol, and salts such as formate salts and potassium or sodium chloride.

Such stabilizers may be useful when the fluids of the present invention are utilized in a subterranean formation having a temperature above about 200° F. (about 93° C.). If included, a stabilizer may be added in an amount of from about 1 to about 50 lbs/Mgal (about 120 to about 6,000 g/Mliter) of fluid.

Scale inhibitors may be added to the fluids of the present invention, for example, when such fluids are not particularly compatible with the formation waters in the formation in which they are used.

These scale inhibitors may include water-soluble organic molecules with carboxylic acid, aspartic acid, maleic acids, sulfonic acids, phosphonic acid, and phosphate ester groups including copolymers, ter-polymers, grafted copolymers, and derivatives thereof.

Examples of such compounds include aliphatic phosphonic acids such as diethylene triamine penta (methylene phosphonate) and polymeric species such as polyvinyl sulfonate.

The scale inhibitor may be in the form of the free acid but is preferably in the form of mono- and polyvalent cation salts such as Na, K, Al, Fe, Ca, Mg, NH₄. Any scale inhibitor that is compatible with the fluid in which it will be used is suitable for use in the present invention.

Suitable amounts of scale inhibitors that may be included in the fluids of the present invention may range from about 0.05 to 100 gallons per about 1,000 gallons (i.e. 0.05 to 100 liters per 1,000 liters) of the fluid.

Any particulates such as proppant, gravel when the formation is a sandstone formation and fibres when the formation is a carbonate formation, that are commonly used in subterranean operations may be used in the present invention (e.g., sand, gravel, bauxite, ceramic materials, glass materials when the formation is a sandstone formation, polymer materials, such as polyglycolic acids and polylactic acids when the formation is a carbonate formation, or wood, plant and vegetable matter, nut hulls, walnut hulls, cotton seed hulls, cement, fly ash, fibrous materials, composite particulates, hollow spheres and/or porous proppant when the formation is a sandstone formation).

It should be understood that the term “particulate” as used in this disclosure includes all known shapes of materials including substantially spherical materials, oblong, fibre-like, ellipsoid, rod-like, polygonal materials (such as cubic materials), mixtures thereof, derivatives thereof, and the like.

In some embodiments, coated particulates may be suitable for use in the treatment fluids of the present invention. It should be noted that many particulates also act as diverting agents. Further diverting agents are viscoelastic surfactants and in-situ gelled fluids.

Oxygen scavengers may be needed to enhance the thermal stability of the GLDA or MGDA. Examples thereof are sulfites and ethorbates.

Friction reducers can be added in an amount of up to 0.2 vol %. Suitable examples are viscoelastic surfactants and enlarged molecular weight polymers.

Crosslinkers can be chosen from the group of multivalent cations that can crosslink polymers such as Al, Fe, B, Ti, Cr, and Zr, or organic crosslinkers such as polyethylene amides, formaldehyde.

Sulfide scavengers can suitably be an aldehyde or ketone.

Viscoelastic surfactants can be chosen from the group of amine oxides or carboxyl butane based surfactants.

The fluids can be used at an increased pressure. Often fluids are pumped into the formation under pressure. Preferably, the pressure used is below fracture pressure, i.e. the pressure at which a specific formation is susceptible to fracture. Fracture pressure can vary a lot depending on the formation treated, but is well known by the person skilled in the art.

In the process of the invention the fluid can be flooded back from the formation. Even more preferably, (part of) the solution is recycled.

It must be realized, however, that GLDA and MGDA, being biodegradable chelating agents, will not completely flow back and therefore are not recyclable to the full extent.

The invention is further illustrated by the Examples below.

### Example 1

Materials

To prepare the acid, 36.5 wt % hydrochloric acid (HCl) was obtained from Mallinckrodt. To simulate the iron concentration in the acid, 99.95% pure hydrated ferric trichloride was obtained from Sigma Aldrich. The cores used were low permeability Indiana Limestone having a diameter of 1.5 inches and a length of 6 inches. The brine used was 5 wt % NaCl. The concentration of HCl was 15%. GLDA and HEDTA were obtained from AkzoNobel Functional Chemicals BV.

Core Flooding Experiments

Experiments were conducted at reservoir conditions of overburden pressure of 1,800 psia and at 200° F. To this end, core flooding experiments were conducted using a Hessler Sleeve with a back pressure of 1,100 psia. The cores were first dried at 250° F. and weighed. Next, they were introduced into the Hessler sleeve and 5 wt % NaCl brine was injected at room temperature until the pressure stabilized. The overburden was kept at (1,600-1,800) psia. The cores were then weighed again after being saturated. The difference in weight gave a measure of the pore volume. The cores were then put back into the core flooding holder and heated to the required temperature (200° F.) while brine was injected at 1 cm³/min.

When the pressure stabilized, half a pore volume of acid solution was injected into the cores, after which the brine injection was resumed. Samples of core effluent were collected until the pressure stabilized and the samples became clear. The pressure drop across the core was recorded throughout the experiment. The cores were then scanned using a CT scanner. Core effluent was analyzed for Fe and Ca using ICP-OES.

Core Flooding Experiments

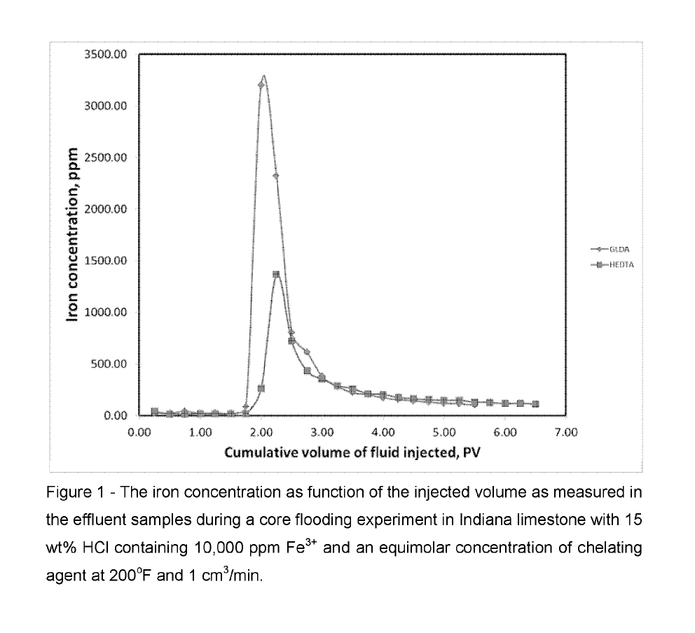

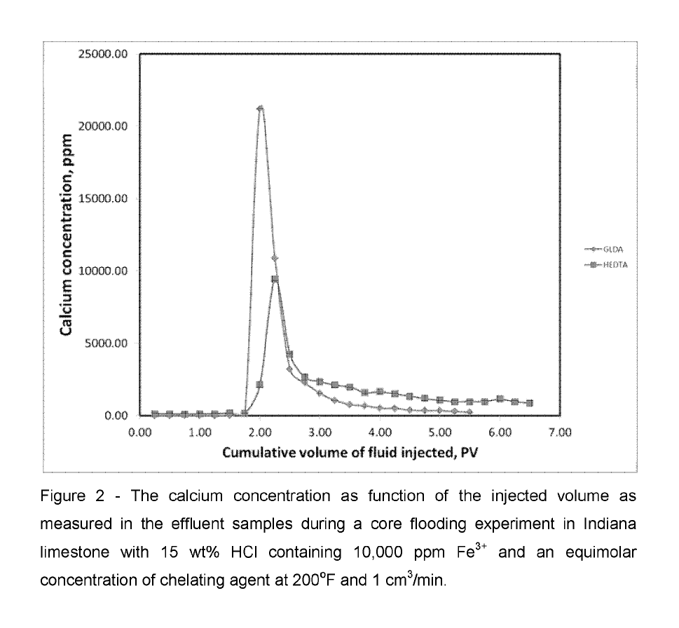

HCl (15%) containing 10,000 ppm Fe and an equimolar amount of GLDA or HEDTA were flowed through low permeability Indiana Limestone cores to determine the damage caused by the iron precipitation. Before the treatment was done, the cores were saturated using 5% NaCl brine, the initial permeabilities were measured, and subsequently the cores were heated to 200° F. Half a pore volume of acid solution was injected at 1 cm³/min. Finally, the cores were left to cool down and 5% NaCl brine was conveyed at constant rate until the pressure restabilized and the final permeability was measured. Under these conditions both GLDA and HEDTA break through the core, which represents the optimal stimulation conditions for this particular type of core at the 200° F. in terms of injection rate and pore volume and therefore represents the most relevant conditions under which iron control is essential. The optimal conditions found in these laboratory core flooding studies can be translated to the field conditions to achieve an optimal stimulation result in addition to sufficient iron control to prevent precipitation reaction due to the presence of uncontrolled iron. The core flooding studies indicate that the differences in iron recovery and calcium dissolution are significant between GLDA and HEDTA. Using GLDA, 45% of all iron was recovered, whereas for HEDTA only 24% was recovered, as shown in FIG. 1 by the analysis of the iron content in the effluent samples. In addition, GLDA dissolves much more calcium, as is illustrated in FIG. 2.

CT scan

Cores were scanned using a CT scan for a better understanding of wormhole creation. During a CT scan the core is virtually cut in slices and an image is made from the inlet side of each individual slice. Wormholes are visible as black dots on the CT scans. When the black dots are visible in all slides, the wormhole has propagated through the entire length of the core and breakthrough has been reached. GLDA creates a wormhole that propagates with an almost constant diameter through the core, whereas for HEDTA the diameter of the core reduces to a diameter below the detection limit of the CT scan. For oil and gas applications prolonged propagation of wormholes with a constant diameter is preferred, as they open up a larger part of the oil or gas-containing reservoir, thus increasing the production from the well.

### Example 2

Following the general procedure from the previous Example 1, a dry Indiana Limestone core with 1.5-inch diameter and 6-inch length was saturated using a 5% NaCl brine after measuring its dry weight. After up to 4 hrs the pressure was stabilized and the core was again weighed. The difference in wet and dry weight was used to calculate the porosity. The stabilized pressure drop was used to calculate the permeability using Darcy's law. After measuring the porosity (0.115) and permeability (1 md=Milli Darcy), brine was again passed through the core while a heating jacket heated the core to a preset temp. When the pressure again stabilized to a lower value (due to a drop in viscosity), 5 wt % HCl containing 10,000 ppm Fe and 1 v/v% corrosion inhibitor were injected at 1 cc/min for ˜0.5 PV (pore volume). Various concentrations of GLDA-NaH₃ (pH=3) were added to the acid to check the iron chelating capacity of the GLDA in core flooding experiments. After completion of the acid injection, the core was flushed with brine.

Samples were collected after the start of the injection of acid until the pressure re-stabilized and the core effluent colour changed back to clear colour. The core effluent samples were then tested using Atomic Absorption Spectroscopy to measure the concentration of iron in the samples. A dilution factor of 100 was used to dilute the samples. The core was scanned using a CT scanner to understand the changes in the core.

It was seen that when GLDA was added, the core effluent was yellow/brown in colour, which indicated the presence of iron. Without the presence of GLDA, the core effluent was clear throughout the injection and flush process. This indicated that nearly all the iron was retained in the core.

At room temperature, precipitation of iron started at a pH of around 1.3 without the presence of any GLDA and was essentially complete by pH 2.6. In the presence of GLDA, the iron in solution was measured to be constant throughout the pH range.

When analyzing the cores after the core flooding experiments with 5 wt% HCl containing 10,000 ppm Fe, it was observed that in the absence of GLDA nearly all the iron precipitated in the core. The permeability of the core fell by nearly 44% at 200° F. (about 93° C.). This indicates a net formation damage. Since only 0.5 pore volume caused a damage of 44% permeability, the injection of more acid indicates a potentially greater damage.

In the presence of GLDA at 200° F., it was seen that GLDA controlled nearly 45% of the iron that was injected into the core when the concentration of GLDA was 5% (1:1 GLDA:Fe). The permeability increased by 22%. This indicates a net stimulation.

When the concentration of GLDA was doubled, nearly 70% of the injected iron came out at 300° F. (about 149° C.). Also, the permeability of the core almost doubled.

Thus, at elevated temperature there is both a higher stimulation effect and the fluid was found to have improved iron control functionality.

1. A process to control iron in subterranean formations wherein a fluid containing comprising glutamic acid N,N-diacetic acid or a salt thereof (GLDA) and/or methylglycine N,N-diacetic acid or a salt thereof (MGDA) is introduced into the formation at a temperature between 77 and 400° F. (about 25 and 204° C.), wherein simultaneously the subterranean formation is treated by introducing the fluid into the formation.

2. (canceled)

3. Process of claim 1, wherein the temperature is between 77 and 300° F. (about 25 and 149° C.).

4. Process of claim 1, wherein the amount of GLDA and/or MGDA in the fluid is between 0.1 and 30 wt % on the basis of total weight of the fluid.

5. Process of claim 1, wherein the fluid comprises GLDA.

6. Process of claim 1, wherein the fluid further comprises another inorganic acid, HCl, HF, an organic acid, citric acid, formic acid or acetic acid.

7. Process of claim 1, wherein the fluid further comprises a corrosion inhibitor.

8. Process of claim 1, wherein the fluid further comprises a biocide and/or bactericide.

9. Process of claim 1, wherein the fluid further comprises one or more additives selected from the group consisting of mutual solvents, anti-sludge agents, water-wetting or emulsifying surfactants, corrosion inhibitor intensifiers, foaming agents, viscosifiers, wetting agents, diverting agents, oxygen scavengers, carrier fluids, fluid loss additives, friction reducers, stabilizers, rheology modifiers, gelling agents, scale inhibitors, breakers, salts, brines, pH control additives, particulates, crosslinkers, salt substitutes, relative permeability modifiers, sulfide scavengers, fibres, nanoparticles, and consolidating agents.

10. Process of claim 1, wherein the fluid has a pH of up to 8.

11. Process of claim 1, wherein the fluid has a pH between 1 and 8.
